(19) United States
(12) Patent Application Publication
(10) Pub. No.: US 2002/0017539 A1
(43) Pub. Date: Feb. 14, 2002

(54) Circumferentially continuous arrangement which is to be worn preferably on the wrist and has a hinged closure

(76) Inventor: Flavio Rota, Biel (CH)

Correspondence Address: BIRCH STEWART KOLASCH & BIRCH, PO BOX 747, FALLS CHURCH, VA, 22040-0747, US

(21) Appl. No.: 09/776,703

(22) Filed: Feb. 6, 2001

(30) Foreign Application Priority Data
Aug. 2, 2000 (EP) 00 810 699.9

(51) Int. Cl. A44C 5/00; G04B 37/00

(52) U.S. Cl. 224/174

(57) ABSTRACT

A circumferentially continuous arrangement which is to be worn preferably on the wrist has a strap (7a, 7b) and a hinged closure (1) which serves for changing the circumferential extent of the arrangement. The hinged closure (1) has a central closure part (3) and at least one toggle lever (11a, 11b) which is connected to the closure part in one end region and has a strap end (5a, 5b) fastened at its other end region. The collapsible toggle lever (11a, 11b, which is connected in each case to the strap end (5a, 5b) and is circumferentially offset with respect to the central closure part (3), and the central closure part (3) are designed and connected to one another such that, for the direct transition from the closed state of the hinged closure (1) to the open state, the central closure part (3) has to be moved outward.

This arrangement, firstly, is closed reliably in a shortened-circumference state by the hinged closure, secondly, can easily be opened to increase the circumference and, thirdly, has an aesthetically pleasing appearance, in particular, in the closed state.

sind nun erfindungsgemäβl zum Öffnen des Verschlusses keine “Fingernagelbrechübunagen” mehr vorzunehmen. Der zentrale Verschlussteil wird nun einfach nach oben bzw. radial nach auβen gezogen; in einer Ausführungsvariante springt er sogar durch einen seitlichen Druck auf das als Armreif ausgebildete Armband auf. Der zentrale Verschlussteil kann zum Öffnen bzw. dann zum weiteren Öffnen mit dem Daumen und einem weiteren Finger seitlich ergriffen werden.

In einer bevorzugten Ausführungsvariante besteht zudem das Armband der Anordnung wenigstens aus zwei unverformbaren, der Handgelenkkontur angepassten, bevorzugt symmetrisch zueinander ausgebildeten Armreifteilen, welche mit einem Armreifschwenkgelenk verschwenkbar miteinander verbunden sind. Jeder Kniehebel, der zentrale Verschlussteil sowie die beiden Armreifteile sind dann derart ausgebildet, dass die Armreifstirnkanten voneinander einen minimalen Abstand erst dann haben, wenn der zentrale Verschlussteil nach auβen um einen Ergreifweg abgehoben ist. Durch ein seitliches Drücken auf die Breitseiten (Auβenseiten) der Armreifteile, radial nach innen anschlieβend an die zusammengeklappten Kniehebel, ist dann ein Öffnen der Anordnung durch ein Hochspringen des zentralen Verschiussteils aus dem geschlossenen Zustand und dessen Ergreifen zum weiteren Öffnen einwandfrei möglich.

Jeden Kniehebel wird man aus zwei Schenkelteilen aufbauen, welche jeweils mit einem Schwenkgelenk miteinander verbunden sind. Es kann nun der Kniehebel mit einem Schenkelteil fest oder auch verschwenkbar mit dem zentralen Verschlussteil verbunden sein. Ist der fest mit dem Verschlussteil verbunden, so ergibt sich der unten beschriebene einfache, fingernagelschonende Schlieβ- und Aufmachvorgang. Die Fingernägel werden nämlich nicht mehr, wie beim Stand der Technik üblich, zum Untergreifen und Hochziehen des die Schwenkteile verbindenden Schwenkgelenks benötigt.

Die erfindungsgemäβe Anordnung läβt sich mit dem oben erwähnten Umlegeverschluss derart ästhetisch ansprechend ausbilden, dass sie bereits alleine am Handgelenk als zu tragendes Schmuckstück wirkt. Wird zudem der zentrale Teil des Umlegeverschiusses mit einem Blickfangobjekt ausgerüstet, ergibt sich ein zweckmäβig ausgebildetes und schönes Schmuckstück, zumal wenn auch noch die Armband- bzw. Armreifteile künstierisch ausgestaltet werden.

Das in einer Ausführungsvariante am Umlegeverschiuss angeordnete Blickfangobjekt ist im Gegensatz zu demjenigen der U.S. Pat. No. 4,748,604 nicht zweigeteilt. Das Blickfangobjekt ist in der Ausführungsvariante der Erfindung ein einstückiges Teil eines symmetrisch aufgebauten Umlegeverschlusses. Hierdurch werden die zu Verletzungen führenden Ecken und Kanten des Bodenteils der U.S. Pat. No. 4,748,604 vermieden. Auch kann mit der erfindungsgemäβen Lösung in einer bevorzugten Ausführung ein ästhetisch schönes Erscheinungsbild eines geschlossenen Armreifs erreicht werden. Bevorzugt wird man das Armband als Uhrenarmband ausbilden. Es sind jedoch auch Ausführungsvarianten möglich, bei denen anstelle des Uhrengehäuses andere Blickfangobjekte, wie oben angedeutet, verwendet werden.

Zum Unterstreichen einer ästhetisch schönen Formgebung sind insbesondere die beiden Kniehebel des Umlegeverschlusses in Ausnehmungen in den Endbereichen des Armbandes bündig versenkbar. Hierzu ist die Summe der Dicken der beiden Schenkelteile jedes Kniehebels bis auf eine Toleranz gleich der Dicke des Armbandendbereichs. Es ist dann jeweils ein Schenkelteil konkav und der andere konvex mit einer der Krümmung des jeweiligen Armbandendbereichs ausgebildet, damit im geschlossenen Zustand der Anordnung die zusammengeklappten Kniehebel oberflächenbündig in die jeweilige Ausnehmung eingelegt sind.

Vorzugsweise wird man zudem die beiden Kniehebel und die dazugehörende Ausnehmung derart ausbilden, daβ die Kniehebel einrastend in den Ausnehmungen liegen und nur durch Anwendung einer leichten Kraft zum Öffnen aus- bzw. aufgeklappt werden können. Auch wird man Kniehebel und Ausnehmung derart ausbilden, daβ ein Durchdruicken durch die Ausnehmung unmöglich ist.

Es soll noch einmal hervorgehoben werden, dass die erfindungsgemäβe Anordnung mit oder ohne Blickfangobjekt am zentralen Verschlussteil des Umlegeverschlusses verwendbar ist, wobei dann der zentrale Verschlussteil bevorzugt als Spange ausgebildet ist.

### KURZE BESCHREIBUNG DER ZEICHNUNGEN

Im Folgenden werden Beispiele der erfindungsgemäβen Anordnung anhand der Zeichnungen näher beschrieben. Weitere Vorteile der Erfindung ergeben sich aus dem nachfolgenden Beschreibungstext. Es zeigen:

FIG. 1 eine Seitenansicht der Anordnung mit einem Blickfangobjekt bei zusammengeklapptem Umlegeverschluβ,

FIG. 2 eine Seitenansicht der in FIG. 1 dargestellten Anordnung bei aufgeklapptem Umlegeverschluβ,

FIG. 3 eine Draufsicht auf die in FIG. 1 dargesteilte Anordnung in der dortigen Blickrichtung III,

FIG. 4 eine Draufsicht auf die in FIG. 2 dargestellte Anordnung in der dortigen Blickrichtung IV,

FIG. 5 einen Querschnitt in vergröβerter Abbildung durch die Anordnung entlang der Linie V-V in FIG. 3 zur Darstellung einer beispielsweisen Einrastung des Kniehebels in einer Ausnehmung im Armreifendbereich,

FIG. 6 eine Variante zu den in den FIGS. 1 bis 5 dargestellten Anordnungen in einem umfangmäβig geschlossenen Zustand, wobei hier zur Darstellung der Kniehebel und deren Rastmechanismen die Endbereiche der Armreifteile der Anordnung weggebrochen dargestellt sind,

FIG. 7 eine Ausschnittsvergröβerung eines Rastelements der in FIG. 6 dargestellten Anordnung,

FIG. 8 eine Seitenansicht, der in FIG. 6 dargestellten Anordnung, bei der der zentrale Verschlussteil des Umlegeverschlusses um einen “Ergreifweg” abgehoben ist und

FIG. 9 eine Seitenansicht der in FIG. 6 gezeigten Anordnung im umfangmäβig vollständig geöffneten Zustand..

### WEGE ZUR AUSFÜHRUNG DER ERFINDUNG

Die in den FIGS. 1 bis 4 dargesteilte Anordnung mit einem als geschlossener Armreif ausgebildeten Armband hat einen Umlegeverschluβ 1. Der Umlegeverschluβ 1 ist als symmetrische Einheit ausgebildet. Er hat als zentrischen Verschlussteil ein Uhrengehäuse 3 als Blickfangobjekt. Am Umlegeverschluβ 1 ist jeweils ein Armbandende 5a bzw. 5b mit einem Schwenkgelenk 6a und 6b befestigt. Das Armband hat ferner zwei konkav gebogene, spiegelsymmetrisch ausgebildete, starre Armreifteile 7a und 7b, welche mit einem Armreifschwenkgelenk 9 miteinander verbunden sind. Die konkave Biegung der Armreifteile 7a und 7b ist der Oberflächenform des menschlichen Handgelenks angepaβt.

Der Umlegeverschluβ 1 hat beidseits des Uhrengehäuses 3 je einen mit einem Schwenkgelenk 10a und 10b gehaltenen Kniehebel 11a und 11b, dessen jeweilige Schenkelteile 13a und 13b bzw. 13c und 13d mit einem Schwenkgelenk 15a bzw. 15b miteinander verschwenkbar verbunden sind. Die Kniehebel 11a und 11b sind spiegelsymmetrisch zueinander ausgebildet. Der Schenkelteil 13a bzw. 13c ist mit dem Schwenkgelenk 10a bzw. 10b verschwenkbarjeweils an einem Seitenflansch 14a bzw. 14b des Uhrengehäuses 3 verschwenkbar gehalten. Jeder Armreifendbereich 5a bzw. 5b hat ausgehend von seinem Ende eine zum Ende hin offene, durch den gesamten Endbereich hindurchgehende, U-förmige Ausnehmung 17a bzw. 17b. Die Längsseiten 19a und 19b bzw. 19c und 19d der Ausnehmung 17a bzw. 17b verlaufen parallel zu den Stirnkanten 18a und 18b derArmreifteile 7a und 7b. Die beiden Armreifteile 7a und 7b sind als gleich breite, der Handgelenkkontur entsprechend gebogene Laschen ausgebildet, was jedoch nicht zwingend ist. Auch eine andere Formgebung wäre möglich. Die Achsen sämtlicher Schwenkgelenke 6a, 6b, 9, 10a, 10b, 15a und 15b verlaufen parallel zueinander.

Die Schenkelteile 13a bis 13d sind ebenfalls entsprechend der Breite b derAusnehmung 17a bzw. 17b bis auf eine Toleranz als gleich breite, konkav bzw. konvex gebogene Laschen ausgebildet. Die Laschenstärke d ist bis auf eine zweite Toleranz halb so dick wie die Dicke des jeweiligen, die betreffende Ausnehmung aufweisenden Armreifendbereichs e. Aufgrund der gerade geschilderten Dickenauswahl und einer geeigneten konkaven bzw. konvexen Formgebung der Schenkelteile 13a bis 13d liegen die vollständig zusammengelegten Kniehebel 5a und 5b, wie in den FIGS. 1 und 3 dargestellt, oberflächenbündig in den jeweiligen Ausnehmungen 17a und 17b.

Die Funktion einer Einrasteinheit, welche jeden zusammengelegten Kniehebel (hier Kniehebel 11a) gegen eine Kraft in jederAusnehmung (hier Ausnehmung 17a) hält, wird anhand der FIG. 5 erläutert. FIG. 5 zeigt einen Schnitt entlang einer Linie V-V in FIG. 3. Dieser Schnitt ist im Ausnehmungsboden 23a geringfügig in Richtung zur Ausnehmungsöffnung 25a hin versetzt geführt. Die jeweilige Einrasteinheit ist in der Nähe des Ausnehmungsbodens 23a bzw. 23b, also möglichst weit weg vom Schwenkgelenk 6a bzw. 6b zwischen dem Armreifteil 7a bzw. 7a und dem betreffenden Schenkelteil 13b bzw. 13d angeordnet. Durch diese vom Schwenkgelenk 6a bzw. 6b distanzierte Anordnung ergibt sich eine Hebelwirkung, wodurch schon eine kleine Einrastwirkung eine vergröβlerte Aufmachkraft erfordert, welche jedoch derart gewähit ist, daβ ein Aufklappen der in je eine Ausnehmung 17a bzw. 17b eingelegten Kniehebel 11a bzw. 11b dennoch mit einer Hand leicht machbar ist.

Der jeweils eine Schenkelteil 13b bzw. 13d weist, wie in FIG. 4 gut erkennbar ist, einen vom Schwenkgelenk 15a bzw. 15b ausgehenden Spalt 29a bzw. 29b auf, der in einem Durchgangsloch 31a bzw. 31b endet. Das Schwenkgelenk 15a bzw. 15b ist nun derart ausgebildet, daβ die beiden Laschenteile 33a und 33b links und rechts des Spaltes 29a bzw. 29b federnd gegeneinander verbiegbar sind. Im Bereich des Schwenkgelenks 15a bzw. 15b ist die Gesamtbreite g des Schenkelteils 13b bzw. 13d um eine Rasttoleranz gröβer als diejenige des Schenkelteils 13a bzw. 13c. Die Rasttoleranz ergibt jedoch bei vollständig zusammengedrücktem Spalt 29a bzw. 29b eine Breite, welche niemals gröβer ist als die Breite b der betreffenden Ausnehmung 17a bzw. 17b am betreffenden Ort. Die Längsseiten 19a bis 19d jeder Ausnehmung 17a und 17b sind in der Nähe des Ausnehmungsbodens 23a bzw. 23b mit einer sich nach auβen leicht verjüngenden Schräge 35a bzw. 35b ausgebildet, welche zur Auβenseite 21a bzw. 21b des jeweiligen Armreifteils 7a bzw. 7b eine Einlaufkante 37a bzw. 37b haben.

Soll das Armband nach einem Überstreifen über die Hand am Handgelenk angelegt werden, werden die annähernd gestreckten Schenkelteile 13a bis 13d der Kniehebel 11a und 11b zusammengeklappt, um den Gesamtumfang des Armbands zu verkleinern. Hierbei werden unter einem Zusammenlegen die jeweils beiden Schenkelteile 13a und 13b sowie 13c und 13d zur jeweiligen Ausnehmung 17a bzw. 17b hinbewegt, bis der jeweilige Schenkelteil 13b bzw. 13d im Bereich des Schwenkgelenks 15a bzw. 15b an der Auβenseite 21a bzw. 21b des jeweiligen Armreifs 7a bzw. 7b in der Nähe des Ausnehmungsbodens 23a bzw. 23b anschlägt. Bei einem weiteren Zusammendrücken werden nun die jeweils beiden Laschenteile 33a und 33b durch die Einlaufkanten 37b und 37b gegen ihre Federwirkung zusammengedrückt. An den nachfolgenden Schragen 35a und 35b entspannen sich die beiden Laschenteile 13b und 13d. Die Kniehebel 11a und 11b sind nun einrastend in der betreffenden Ausnehmung 17a bzw. 17b gehalten.

Damit beim Eindrücken der Kniehebel 11a und 11b diese nicht durch die Ausnehmung 17a und 17b hindurch auf das Handgelenk drückbar sind, ist jeder Ausnehmungsboden 23a und 23b mit einer Schräge 41a bzw. 41b 5versehen, welche sich zur Innenseite 43 des jeweiligen Armreifteils 7a bzw. 7b hin verjüngt.

Zum Öffnen der Anordnung wird mit Daumen und Zeigefinger etwa in der Mitte der Armreifteile 7a und 7b in Richtung der Pfeile 45a und 45b gedrückt, worauf das den zentralen Verschlussteil bildende Uhrengehäuse 3 in Richtung 46 um einen Ergreifweg radial nach aussen springt. Das Uhrengehäuse 3 kann dann zum weiteren Öffnen bis in den in FIG. 2 gezeigten Zustand seitlich mit Daumen und Zeige- bzw. Mittelfinger ergriffen und weiter radial nach aussen zur weiteren Umfangsvergröβerung der Anordnung gezogen werden.Dieser Vorgang des Öffnens ist unten anhand der FIGS. 8 und 9 für eine Ausführungsvariante beschrieben.

Die beiden Ausnehmungen 17a und 17b sind oben als vollständig durchgehender Freiraum beschrieben worden. Es kann aber auch bei gleicher Wirkung eine Ausnehmung verwendet werden, welche nicht voliständig durch den betreffenden Armreifteil geht; d. h. es würde noch ein Ausnehmungsboden mit einer Wandstärke zur Innenseite te 43 bestehen bleiben. Die oben beschriebene Ausnehmungsausgestaltung gestattet jedoch eine einfachere Herstellung bei einer dennoch schönen Erscheinung.

Auch muβ der Ausnehmungsboden 23a bzw. 23b, wie oben dargestellt, nicht unbedingt eine senkrechte Fläche zu den Längsseiten 19a bis 19d der Ausnehmungen 17a und 17b haben. Es kann auch eine gekrümmte Fläche verwendet werden. Der oben beschriebene Ausnehmungsboden 23a bzw. 23b ist jedoch mechanisch einfach herstellbar.

Das Blickfangobjekt muβ nicht unbedingt der zentrische Teil des symmetrisch ausgebildeten Umlegeverschlusses 1 sein. Es kann auch ein zentrischer Teil ohne Blickfangobjekt verwendet werden und dann ein Blickfangobjekt an einem oderje ein Blickfangobjekt an beiden Schenkelteilen 13a und/oder 13b angeordnet werden. Auch muss der Umlegeverschluss nicht symmetrisch ausgebildet sein. Er kann z. B. auch mit nur einem Kniehebel ausgebildet werden.

Wie oben beschrieben, hat das Armband die beiden starren Armreifteile 7a und 7b. Diese Armreifteile 7a und 7b können aus einem Edelmetall oder sonstigen Metallen sowie auch aus Kunststoff bestehen. Anstelle der starren Armreifteile 7a und 7b können jedoch auch biegeelastische Armbandteile verwendet werden.

Die oben beschriebene Rasteinheit ist lediglich als Beispiel zu verstehen. Es könnte beispielsweise auch die Achse der Schwenkgelenke 15a und 15b überstehend und beiseitig federnd ausgebildet werden. In den Längsseiten 19a bis 19d ware dann am entsprechenden Ort eine sich nach oben erweiternde Sackbohrung anzubringen.

In den FIGS. 6 und 7 ist eine Ausführungsvariante zu der in den FIGS. 1 bis 5 dargestellten Anordnung gezeigt. Auch hier ist ein Uhrengehäuse 47 als Blickfangobjekt und zentraler Verschlussteil eines symmetrischen Umlegeverschlusses vorhanden. Die Armreifteile 50a und 50b sind analog zu den Armreifteilen 7a und 7b ausgebildet und ebenfalls mit einem Armreifschwenkgelenk, hier mit 51 gekennzeichnet, schwenkbar verbunden. Auch hier hat der Umlegeverschluss 49 beidseits je einen Kniehebel 53a und 53b. Jeder Kniehebel hat ebenfalls zwei Schenkelteile 54a und 54b sowie 54c und 54d, welche jeweils mit einem Schwenkgelenk 55a bzw. 55b verschwenkbar verbunden sind. Im Gegensatz zur der in den FIGS. 1 bis 5 dargestellten Anordnung sind hierjedoch die Schenkelteile 54a und 54c starr mit dem Uhrengehäuse 47 (zentraler Verschlussteil) verbunden. Die Schenkelteile 54b und 54d sind jedoch analog zu den Schenkelteilen 13b und 13d bewegbar und mit je einem Schwenkgelenk 60a und 60b am Armreifendbereich 62a und 62b verschwenkbar gehalten. Durch diese Ausgestaltung ergibt sich ein einwandfreies “Aufspringen” der Anordnung durch ein seitliches Drücken auf die Armreifteile 50a und 50b unterhalb der unten beschriebenen Ausnehmungen 61a und 61b in Richtung der Pfeile 57a und 57b. Das Aufspringen wird zudem dadurch ermöglicht, dass die Schwenkgelenkachsen 55a und 55b im geschlossenen Zustand des Umlegeverschlusses 49 einen kürzeren Abstand zum Armreifschwenkgelenk 51 haben als die Schwenkgelenke 60a und 60b. Den “aufgesprungenen” Zustand der Anordnung zeigt FIG. 8. In diesem Zustand ist der Abstand k₁ der Armreifstirnkanten 59a und 59b voneinander geringer als der Abstand k₂ im geschlossenen Zustand, wie ihn FIG. 6 zeigt. Diese Abstandsverringerung verringert jedoch auch den Durchmesser der Anordnung; er ist jedoch so gering, dass eine Quetschung des Handgelenks nicht erfolgt. Im “aufgesprungenen Zustand ist das Uhrengehäuse 47 um einen “Ergreifweg” 64 radial nach aussen abgehoben. Das Uhrengehäuse kann nun gut mit dem Daumen und dem Zeigebzw. Mittelfinger seitlich ergriffen werden, wodurch die Anordnung zur weiteren Umfangsvergröβerung in den in FIG. 9 gezeigten Zustand gebracht werden kann. Hierdurch vergröβert sich der Abstand der gegenuberliegenden Armreifstirnkanten auf k₃. Die geöffnete Anordnung kann nun über das Handgelenkgestreift werden.

Die jeweils beiden Schenkelteile 54a bis 54d der Kniehebel 53a und 53b sind rastend in einer zur Ausnehmung 17a und 17b analog ausgebildeten Ausnehmung 61a sowie 61 b im Armreifteil 50a sowie 50b gehalten. Die Rastkraft ist so groβ gewähit, dass ein Öffnen der Anordnung durch nicht beabsichtigte seitliche Stösse nicht erfolgt. Auch müssten diese Stösse beidseits zur gleichen Zeit erfolgen. Ein einseitiger Stoβ im normalen Rahmen (d. h. nicht verletzend) zeigt keine Wirkung. Die Breite der jeweils zwei laschenartig ausgebildeten Schenkelteile 54a und 54b sowie 54c und 54d ist derart gewähit, dass diese Teile mit einer Spielpassung in die Ausnehmung 61a bzw. 61b eingebracht werden können. Die rastende Halterung ist im Gegensatz zur Rasthalterung der in den FIGS. 1 bis 5 gezeigten Anordnung anders ausgebildet.

Die in FIG. 7 dargestellte Rasthalterung zeigt in einer vergröβerten Darstellung den Schenkelteil 54c. Der Schenkelteil 54a ist hierzu analog, jedoch spiegelbildlich ausgebildet. Dieser Schenkelteil 54c hat beidseits jeweils einen etwa in der Mitte nach unten hervorstehenden Ansatz 63 mit einem Noppen 65. Im geschlossenen Zustand der Anordnung greift dieser Noppen 65 um ein in jeder Ausnehmung 61a bzw. 61b angeordnetes Rohr 66. Jedes Rohr 66 wird in der jeweiligen Ausnehnung durch einen in ihm verlaufenden Quersteg 67 gehalten. Der Absatz 63 greift im geschlossenen Zustand der Anordnung durch jeweils eine seitliche Auskerbung 69 am Schenkelteil 54b bzw. 54d. Der Schenkelteil 54d ist zum Schenkelteil 54b spiegelsymmetrisch ausgebildet. Beim Öffenen durch seitlichen Druck auf die Armreifteile 50a und 50b wird die Noppe 65 vom Rohr 66 bzw. Quersteg 67 weg, d. h. schräg nach aussen weggedrückt und damit die Rastung aufgehoben. Durch eine Ausbildung des einen Rastteils als Quersteg 67 mit einem umhüllenden Rohr 66 kann ein Materialabrieb sehr stark reduziert und damit die Lebensdauer der Rasteinheit signifikant vergröβert werden.

Der in jeder Ausnehmung 61a und 61b angeordnete Quersteg 67 verhindert zudem ein Durchdrücken der Kniehebel 53a und 53b durch die Ausnehmung 61a und 61b hindurch. Die starre Befestigung der Schenkelteile 54a und 54b am zentralen Verschussteil 47 wird hierdurch zudem gegen Abbrechen geschützt.

Zum Schlieβen der Anordnung am Handgelenk wird diese über die Hand gestreift. Anschlieβend werden die beiden Armreifteile 50a und 50b ungefähr am Ort der Pfeile 57a und 57b leicht zwischen dem Daumen und einem oder einigen Fingern der anderen Hand zusammengedrückt. Aufgrund der starr und fest mit dem zentralen Verschlussteil 47 (Uhrengehäuse) verbundenen Schenkelteil 54a und 54c kommt beim Zusammendrücken der zentrale Verschlussteil 47 über der Lücke zwischen den beiden Armreifstirnkanten 59a und 59b zu liegen. Werden nun die Armreifteile 50a und 50b losgelassen, so fällt der Umlegeverschluss 49, sofern sich dieser an der Handgelenkoberseite befindet, aufgrund der Schwerkraft in sich zusammen. Die Kniehebel 53a und 53b liegen dann teilweise in den Ausnehmungen 61a und 61b. Durch einen Druck auf die in die Ausnehmungen 61a und 61b eingeklappten Schenkelteile 54a und 54c erfolgt dann ein oberflächenbündiges, einrastendes Einklinken der Kniehebel 53a und 53b in die Ausnehmungen 61a und 61b. Ein Verbiegen von Teilen des Umlegeverschlusses 49 durch unachtsames Schlieβen ist hier nicht mehr möglich; Fehlbedienungsmögtichkeiten sind ausgeschlossen. Zum Verschlieβen wird man bevorzugt auf die Schenkelteile 54a und 54c am Ort der Rastelemente drücken. Es kann aber auch ein Schlieβen alleine durch ein Drücken auf den zentralen Verschlussteil erfolgen.

1. Eine bevorzugt am Handgelenk zu tragende, in sich umfangmäβig geschlossene Anordnung mit einem Armband (7a, 7b; 50a, 50b) und einem zur Umfangsweitenänderung der Anordnung dienenden Umlegeverschluss (1; 49), der einen zentralen Verschlussteil (3; 47) und wenigstens einen mit diesem in seinem einen Endbereich verbundenen Kniehebel ( 11a, 11b; 53a, 53b) hat, an dessen anderen Endbereich ein Armbandende (5a, 5b) befestigt ist, dadurch gekennzeichnet, dass der mit dem Armbandende (5a, 5b) verbundene, zum zentralen Verschlussteil (3; 47) umfangmäβig versetzte, zusammenklappbare Kniehebel (11a, 11b; 53a, 53b) und der zentrale Verschlussteii (3; 47) derart ausgebildet und miteinander verbunden sind, dass beim unmittelbaren Übergang vom geschlossenen Zustand des Umlegeverschlusses (1; 49) zum offenen Zustand der zentrale Verschlussteil (3; 47) nach aussen zu bewegen ist bzw. sich bewegt.

2. Anordnung nach Anspruch 1, dadurch gekennzeichnet, dass der Umlegeverschluss (1; 49), bevorzugt dessen zentraler Verschlussteil ein Blickfangobjekt (3; 47) trägt.

3. Anordnung nach Anspruch 1 oder 2, gekennzeichnet durch eine, im an den Umlegeverschluβ (1; 49) anschlieβenden Armbandendbereich (5a, 5b) angeordnete Ausnehmung (17a, 17b; 61a, 61b), in der bei geschlossenem Umlegeverschluss (1; 49) jeweils ein Kniehebel (11a, 11b; 53a, 53b) zusammengeklappt eingelegt ist, und durch bevorzugt pro Kniehebel (11a bzw. 11b; 53a bzw. 53b) jeweils zwei mit einem Schwenkgelenk (15a, 15b; 55a, 55b) gelenkig miteinander verbundene Schenkelteile 13a-d; 54a-d) sowie durch insbesondere einen zweiten Kniehebel (11a bzw. 11b; 53a bzw. 53b), wobei dann vorzugsweise der Umlegeverschluss (1; 49) als symmetrische Einheit mit beidseits des zentralen Verschlussteiles (3; 47) einem Kniehebel (11a, 11b; 53a, 53b) ausgebildet ist.

4. Anordnung nach Anspruch 3, dadurch gekennzeichnet, dass die Summe der Dikken des jeweils ersten und zweiten Schenkelteils (13a/b, 13c/d; 54a/b, 54c/d) jedes Kniehebels (11a, 11b; 53a, 53b) bis auf eine Toleranz gleich der Dicke des Armbandendbereichs ist und bevorzugt jeweils ein Schenkelteil konkav (13a, 13c; 54a, 54c) und der andere konvex (13b, 13d; 54b, 54d) mit einer der Krümmung des jeweiligen Armbandendbereichs (5a, 5b) ausgebildet ist, damit im geschlossenen Zustand der Anordnung die zusammengeklappten Kniehebel (11a, 11b; 53a, 53b) oberfächenbündig in die jeweilige Ausnehmung (17a, 17b; 61a, 61b) eingelegt sind.

5. Anordnung nach Anspruch 3 oder 4, dadurch gekennzeichnet, dass jedes Schwenkgelenk (15a, 15b; 55a, 55b) der beiden Schenkelteile (13a/13b, 13c/13d; 54a/54b, 54c/54d) im geschlossenen Zustand der Anordnung vom zentralen Verschlussteil (3; 47) entfernt zu liegen kommt und bevorzugt ein Schenkelteil (54a, 54c) jedes Kniehebels (53a, 53b) fest, d. h. unverschwenkbar mit den zentralen Verschlussteil (47) verbunden ist, wodurch der zentrale Verschlussteil in einen annähernd geschlossenen Zustand fallen kann, aus dem er in den vollstandig geschlossenen Zustand ohne Fehlbetätigungsmöglichkeit eindrückbar ist.

6. Anordnung nach einem der Ansprüche 1 bis 5, gekennzeichnet durch eine Rasteinheit, welche die zusammengelegten Kniehebel (11a, 11b; 53a, 53b) in der betreffenden Ausnehmung (17a, 17b; 61a, 61b) bis zu einer Aufmachkraft halten.

7. Anordnung nach Anspruch 6, dadurch gekennzeichnet, daβ die Rasteinheit zweiteilig ausgebildet ist, wobei ein erster Rastelementteil bevorzugt eine in der Ausnehmung (17a, 17b) angeordnete, bevorzugt in der Nähe des Ausnehmungsbodens (23a, 23b) gegen die Armband- bzw. Armreifauβenseite (39a, 39b) verjüngend verlaufende Schrage (41a, 41b) und der andere Rastelementteil eine Verbreiterung am Kniehebel (15a, 15b) ist, wobei vorzugsweise einer der Kniehebel (11a, 11b), insbesondere der im zusammengelegten Zustand zuoberst zu liegen kommende Kniehebel (13a, 13c) einen zum Kniegelenk (15a, 15b) hin laufenden, zusammendrückbaren Spalt (29a, 29b) zur Erzeugung einer Federwirkung hat.

8. Anordnung nach Anspruch 3, gekennzeichnet durch einen Anschlag (41a, 41b; 65, 67) in jeder Ausnehmung (17a, 17b; 61a, 61b)zur Verhinderung eines Hindurchdrückens des Kniehebels (11a, 11b; 53a, 53b) durch die Ausnehmung (17a, 17b; 61a, 61b).

9. Anordnung nach Anspruch 2, dadurch gekennzeichnet, daβ das Blickfangobjekt (3; 47) ein Uhrengehäuse ist.

10. Anordnung nach einem der Ansprüche 1 bis 9, dadurch gekennzeichnet, dass das Armband wenigstens zwei unverformbare, der Handgelenkkontur angepasste, bevorzugt symmetrisch zueinander ausgebildete Armreifteile (7a, 7b; 50a, 50b) hat, welche mit einem Armreifschwenkgelenk (9; 51) verschwenkbar miteinander verbunden sind und bevorzugt jeder Kniehebel (11a, 11b; 53a, 53b), der zentrale Verschlussteil (3; 47) sowie die beiden Armreifteile (7a, 7b; 50a, 50b) derart ausgebildet sind, dass der Abstand k₁ der Armreifstirnkanten (59a, 59b) voneinander erst minimal ist, wenn der zentrale Verschlussteil (3; 47) nach aussen um einen Ergreifweg (64) abgehoben ist, damit durch seitliches Drücken (45a, 45b; 57a, 57b) auf die Armreifteile (7a, 7b; 50a, 50b) ein Öffnen der Anordnung durch ein Hochspringen des zentralen Verschlussteils (3; 47) aus dem geschlossenen Zustand und dessen Ergreifen zum weiteren Öffnen möglich ist.

Eine bevorzugt am Handgelenk zu tragende, in sich umfangmäβig geschlossene Anordnung hat ein Armband (7a, 7b) und einen zur Umfangsweitenänderung der Anordnung dienenden Umlegeverschluss (1). Der UmlegeverschIuss (1) hat einen zentralen Verschlussteil (3) und wenigstens einen mit diesem in seinem einen Endbereich verbundenen Kniehebel (11a, 11b), an dessen anderen Endbereich ein Armbandende (5a, 5b) befestigt ist. Der jeweils mit dem Armbandende (5a, 5b) verbundene, zum zentralen Verschlussteil (3) umfangmäβig versetzte, zusammenklappbare Kniehebel (11a, 11b) und der zentrale Verschlussteil (3) sind derart ausgebildet und miteinander verbunden, dass beim unmittelbaren Übergang vom geschlossenen Zustand des Umlegeverschlusses (1) zum offenen Zustand der zentrale Verschlussteil (3) nach aussen zu bewegen ist.

Diese Anordnung ist erstens in einem umfangverkürzten Zustand durch den Umlegeverschluss sicher geschlossen, zweitens zur Umfangvergröβerung auf einfache Art und Weise aufmachbar und hat drittens insbesondere im geschlossenen Zustand ein ästhetisch schönes Erscheinungsbild.

### TECHNICAL FIELD

The invention relates to an arrangement which is to be worn preferably on the wrist in accordance with the preamble of Patent claim 1.

### PRIOR ART

An eye-catching object is understood as being a jewelry element (precious-stone arrangements, crowns, etc.), a watchcase, a display element (mini calculator, mini pager, etc.), etc.

Hinged closures are used, in particular, for watch-straps (although this is not necessarily the case). They are also referred to as folding closures. The hinged closure with the strap ends fastened on it forms a continuous, so-called strap. When the hinged closure is opened, only the circumference of the strap is increased such that the hand can be slipped in and out. The strap is not separated in any way.

A strap is understood as being all types of means which can enclose the forearm in the vicinity of the wrist and at the ends of which a hinged closure may be provided. In the broader sense, a strap is also understood as being a means which can be placed around the foot in the region of the ankle. In the broadest sense, a necklace and a belt also fall into this category.

An arrangement with a Z-closure on a watch-strap is known from U.S. Pat. No. 4,748,604. The known closure had a watchcase as an eye-catching object. The watchcase was designed in two parts with a top part bearing a watch movement and with a watch base. The top part and the watch base were connected in an articulated manner to a link. The watch base was designed such that the top part and link could be positioned in it. One strap end was articulated on the top part and the other strap end was articulated on the bottom part. For opening purposes, it was necessary to use one's fingernail to raise one side of the watchcase from the watch base as “Z-base”.

British Patent Application GB-A 405 452 describes a circumferentially closed arrangement with a hinged closure. The hinged closure had a central closure part with toggle levers arranged symmetrically on both sides with respect to the closure part. The central closure part had a timepiece as an eye-catching object. Each toggle lever had two leg parts connected to a pivot articulation, in which case that end of a first leg part directed away from the pivot articulation was connected pivotably to the watchcase and that end of the second leg part directed away from the pivot articulation was connected pivotably to the strap end. In the closed state of the arrangement, the leg parts were in the collapsed state, in which case the first leg part came to rest on the inner side, and the second leg part came to rest on the outer side, of the arrangement. In order to open the arrangement or the hinged closure, the fingernail was used to grip beneath the pivot articulation, connecting the two leg parts and located adjacent to the central closure part, and to draw it outward, as a result of which the hinged closure swung open and thus increased the circumference of the arrangement. It was then possible for the arrangement to be slipped off the wrist.

An arrangement with a hinged closure in which a watchcase was arranged is likewise known from Swiss Patent CH-A 662 031. In each case two fork-shaped pivot levers which are connected to one another by an articulation at the fork-tine ends gripped around the watchcase to the left and right. The watchcase was thus the central part (“common supporting plate”) of the hinged closure. The two articulations at the fork-tine ends were located beside the other, on the outside of the watchcase, in the closed state. In order to open the hinged closure (increase the circumference of the arrangement) it was necessary to use one's fingernail to grip beneath at least one of the articulations and draw the same outward.

German Patent DE-C 621 286 has disclosed an arrangement which was not of the generic type and had a closure and a link strap. An eye-catching object was not present. In addition, the closure mainly had a central closure part, at the ends of which in each case a single leg was arranged by way of a first pivot articulation. At the leg end not connected to the central closure part, the link strap was then fastened by a second pivot articulation. The central closure part is arranged such that it remains directed towards the inner side of the arrangement, that is to say the wrist, in each case. In the closed state of the arrangement, the second pivot articulations were located on the central closure part. In order to open the arrangement, it was necessary to use one's fingernail to grip beneath at least one of the second pivot articulations and draw the same upward. An arrangement analogous to this is described in EP-A 0 208 168.

### OBJECT OF THE INVENTION

The object of the invention is to provide a circumferentially continuous arrangement which is to be worn preferably on the wrist and has a strap and a hinged closure which serves for changing the circumference, said arrangement, firstly, remaining reliably in a shortened-circumference state by means of a collapsed hinged closure, secondly, being easily opened, in particular in a “fingernail-friendly” manner, to increase the circumference, and thirdly, having an aesthetically pleasing appearance in particular, in the closed state.

### ACHIEVING THE OBJECT

The object is achieved in that the collapsible toggle lever, which is connected to the strap end and is offset circumferentially with respect to the central closure part, and the central closure part are designed and connected to one another such that, for the direct transition from the closed state of the hinged closure to the open state, the central closure part has to be moved, or moves, outward. This means, that for opening purposes, the central closure part has to be drawn outward, i.e. upward in the case of an arrangement which has to be worn on the wrist, or it moves a predetermined radical distance in the outward direction; it springs open such that it can be gripped to good effect. The hinged closure may be constructed asymmetrically with one toggle lever or asymmetrically or symmetrically with two toggle levers.

In contrast to the closures described in U.S. Pat. No. 4,748,604, GB-A 405 452, CH-A 662 031, DE-C 621 286 and EP-A 0 208 168, no more “fingernail-breaking actions” are necessary, according to the invention, in order to open the closure. The central closure part is now simply drawn upward or radially outward; in one variant, it even springs open by a lateral pressure being applied to the bracelet-design strap. The central closure part can be gripped laterally by the thumb and a further finger in order to be opened and then to be opened further.

In a preferred variant, in addition, the strap of the arrangement comprises at least two non-deformable bracelet parts which are adapted to the wrist contour, are designed preferably symmetrically to one another and are connected pivotably to one another by a bracelet pivot articulation. Each toggle lever, the central closure part and the two bracelet parts are then designed such that the bracelet end edges are only spaced apart from one another by a minimal spacing when the central closure part is raised up outward by a gripping distance. By lateral pressing on the broad sides (outer sides) of the bracelet parts, in a radially inward direction following the collapsed toggle levers, opening of the arrangement is then satisfactory possible by virtue of the central closure part springing up from the closed state and being gripped in order to be opened further.

Each toggle lever is constructed from two leg parts which are each connected to one another by a pivot articulation. The toggle lever may then be connected fixedly or also pivotably to the central closure part by way of one leg part. If it is connected fixedly to the closure part, this results in the straightforward, fingernail-friendly closing and opening operation described hereinbelow. This is because it is no longer the case, as with the prior art, that it is necessary to use one's fingernails to grip beneath the pivot articulation, which connects the pivot parts, and to draw the same upward.

The arrangement according to the invention can be designed in an aesthetically pleasing manner, using the abovementioned hinged closure, such that even on its own on the wrist it acts as a piece of jewelry which can be worn [sic]. If, in addition, the central part of the hinged closure is provided with an eye-catching object, this gives an expediently designed and attractive piece of jewelry, especially if the strap or bracelet parts are also artistically fashioned.

In contrast to that in U.S. Pat. No. 4,748,604, the eye-catching object arranged on the hinged closure in one variant is not in two parts. In the variant of the invention, the eye-catching object is a single-piece part of a symmetrically constructed hinged closure. This avoids the injury-causing corners and edges of the base part from U.S. Pat. No. 4,748,604. In a preferred embodiment, it is also possible for the solution according to the invention to achieve an aesthetically pleasing appearance of a closed bracelet. The strap will preferably be designed as a watch-strap. However, variants in which use is made of eye-catching objects other than the watchcase, as has been indicated above, are also possible.

To emphasize an aesthetically pleasing shaping, it is possible, in particular, for the two toggle levers of the hinged closure to be positioned in a flash manner in cutouts in the end regions of the strap. For this purpose, the sum of the thicknesses of the two leg parts of each toggle lever, apart from a tolerance, is equal to the thickness of the strap end region. In this case, in each case one leg part is of concave design and the other is of convex design with one of the curvature [sic] of the respective strap end region in order that, in the closed state of the arrangement, the collapsed toggle levers are positioned in a surface-flash manner in the respective cutout.

In addition, the two toggle levers and the associated cutout will preferably be designed such that the toggle levers are located with latching action in the cutouts and can be swung out or open for opening purposes only by a slight force being applied. In addition, the toggle lever and cutout will be designed such that it is not possible for the toggle lever to be pressed through the cutout.

It should also be envisaged again that the arrangement according to the invention can be used with or without an eye-catching object on the central closure part of the hinged closure. The central closure part then being designed preferably as a clasp.

### BRIEF DESCRIPTION OF THE DRAWINGS

Examples of the arrangement according to the invention are described in more detail hereinbelow with preference to the drawings. Further advantages of the invention can be gathered from the following description text. In the drawings:

FIG. 1 shows a side view of the arrangement with an eye-catching object, with the hinged closure in the collapsed state,

FIG. 2 shows a side view of the arrangement illustrated in FIG. 1, with the hinged closure in the swung-open state,

FIG. 3 shows a plan view of the arrangement illustrated in FIG. 1 in the viewing direction III from FIG. 1,

FIG. 4 shows a plan view of the arrangement illustrated in FIG. 2 in viewing direction IV from FIG. 2,

FIG. 5 shows a cross section, on an enlarged scale through the arrangement along line V-V in FIG. 3 in order to illustrate an example of the toggle lever latching in a cutout in the bracelet end region,

FIG. 6 shows a variant of the arrangements illustrated in FIGS. 1 to 5, this variant being in the circumferentially closed state and, in order to illustrate the toggle levers and the latching mechanisms thereof, the end regions of the bracelet parts of the arrangement being illustrated in the broken-away state,

FIG. 7 shows an enlarged detail of a latching element of the arrangement illustrated in FIG. 6,

FIG. 8 shows a side view, of the arrangement illustrated in FIG. 6, in which the central closure part of the hinged closure is raised by a “gripping distance”, and

FIG. 9 shows a side view of the arrangement shown in FIG. 6, the arrangement being in the circumferentially fully open state.

### METHODS OF IMPLEMENTING THE INVENTION

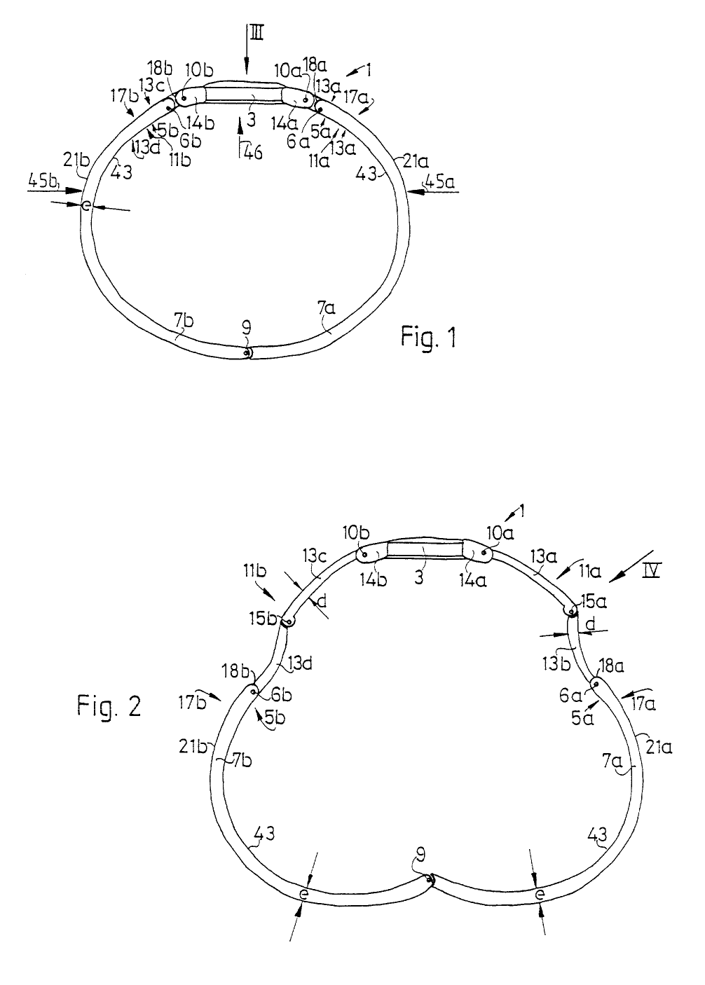

The arrangement illustrated in FIGS. 1 to 4, with a strap designed as a closed bracelet, has a hinged closure 1. The hinged closure 1 is designed as a symmetrical unit. As central closure part, it has a watchcase 3 as eye-catching object. In each case one strap end 5a and 5b is fastened on the hinged closure 1 by a pivot articulation 6a and 6b, respectively. Furthermore, the strap has two concavely curved, mirror-symmetrical, rigid bracelet parts 7a and 7b, which are connected to one another by a bracelet pivot articulation 9. The concave curvature of the bracelet parts 7a and 7b is adapted to the shape of the surface of the human wrist.

On both sides of the watchcase 3, the hinged closure 1 has in each case one toggle lever 11a and 11b which is retained by pivot articulation 10a and 10b and of which the respective leg parts 13a, 13b and 13c, 13d are connected pivotably to one another by a pivot articulation 15a and 15b, respectively. The toggle levers 11a and 11b are mirror-symmetrical to one another. The leg part 13a and 13c is retained pivotably in each case on a side flange 14a and 14b, respectively, of the watchcase 3 such that it can be pivoted by the pivot articulation 10a and 10b, respectively. Starting from its end, each strap end region 5a and 5b has a U-shaped cutout 17a and 17b, respectively, which is open in the direction of the end and passes through the entire end region. The longitudinal sides 19a, 19b and 19c, 19d of the cutouts 17a and 17b, respectively, run parallel to the end edges 18a and 18b of the bracelet parts 7a and 7b. The two bracelet parts 7a and 7b are formed as equal-width links curved in accordance with the wrist contour, although this is not necessarily the case. Other shaping would also be possible. The axes of all the pivot articulations 6a, 6b, 9, 10a, 10b, 15a and 15b run parallel to one another.

The leg parts 13a to 13d are likewise designed, corresponding to the width b of the cutout 17a and 17b apart from a tolerance, as same-width, concavely or convexly curved links. The link thickness d, apart from a second tolerance, is half the thickness of the respective bracelet end region e, which contains the relevant cutout. On account of the just-described thickness selection and of suitable concave and convex shaping of the leg parts 13a to 13d, the fully collapsed toggle levers 5a and 5b, as is illustrated in FIGS. 1 and 3, are located in a surface-flash manner in the respective cutouts 17a and 17b.

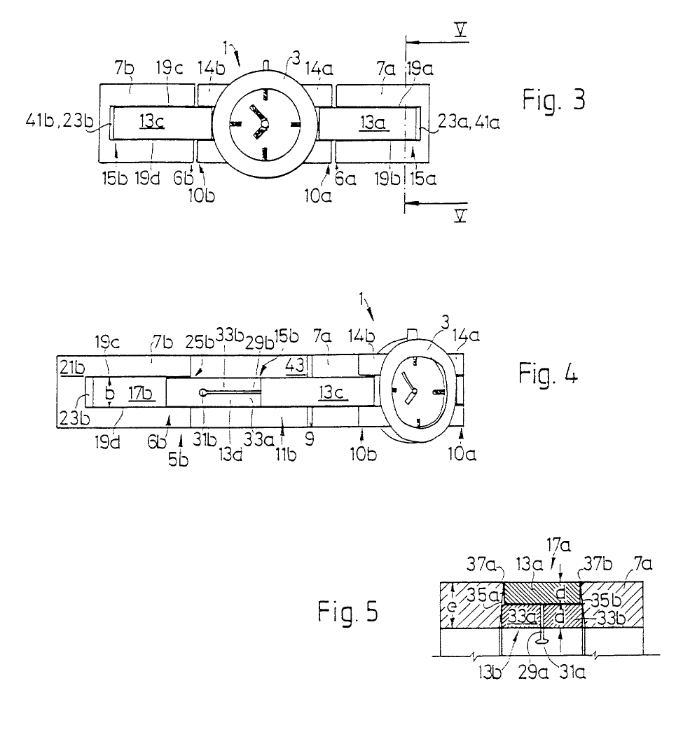

The function of a latching-in unit, which retains each collapsed toggle lever (in this case toggle lever 11a) in each cutout (in this case cutout 17a) counter to a force, is explained with reference to FIG. 5. FIG. 5 shows a section along run V-V in FIG. 3. This section is routed in the cutout base 23a, offset slightly in the direction of the cutout opening 25a. The respective latching-in unit is arranged in the vicinity of the cutout base 23a and 23b, that is to say as far away as possible from the respective pivot articulation 6a and 6b between respective bracelet part 7a and 7a [sic] and the respective relevant leg part 13b and 13d. This arrangement spaced apart from the pivot articulation 6a and 6b results in a lever action, as a result of which even just a small latching-in action requires an increased opening force, although the latter is selected such that the toggle levers 11a and 11b positioned in a respective cutout 17a and 17b can nevertheless be swung open easily using one hand.

As can easily be seen in FIG. 4, the respectively one leg part 13b and 13d has a respective gap 29a and 29b which extends from the respective pivot articulation 15a and 15b and terminates in a respective through-passage hole 31a and 31b. The pivot articulation 15a and 15b, then, is designed such that the two links 33a and 33b, respectively, can be bent resiliently in relation to one another to the left and right of the gap 29a, 29b, respectively. In the region of the pivot articulation 15a and 15b, the overall width g of the leg part 13b and 13d, respectively, is greater, by a latching tolerance, than that of the leg part 13a and 13c, respectively. However, with the gap 29a and 29b in the completely compressed state, the latching tolerance provides a width which is not at any time greater than the width b of the relevant cutout 17a and 17b, respectively, at the relevant location. The longitudinal sides 19a to 19d of each cutout 17a and 17b are designed, in the vicinity of the respective cutout base 23a and 23b, with a respective slope 35a and 35b which tapers outward slightly and have [sic] a respectively run-in edge 37a and 37b in relation to the respectively outer side 21a and 21b of the respective bracelet part 7a and 7b.

If the strap is to be put on the wrist once it has been slipped over the hand, the more or less straightened-out leg parts 13a to 13d of the toggle levers 11a and 11b are collapsed in order to decrease the overall circumference of the strap. In this case, with a collapsing action, the in each case two leg parts 13a, 13b and 13c, 13d are moved in the direction of the respective cutouts 17a and 17b, until the respective leg part 13b and 13d, in the region of the respective pivot articulation 15a and 15b, strikes against the respective outer side 21a and 21b of the respective bracelet 7a and 7b in the vicinity of the respective cutout base 23a and 23b. With further compression, the in each case two link parts 33a and 33b are then compressed counter to their spring action by way of the run-in edges 37b [sic] and 37b. On the following slopes 35a and 35b, the two leg parts 13b and 13d are relieved of stressing. The toggle levers 11a and 11b are then retained with latching action in the relevant cutouts 17a and 17b, respectively.

In order that, when the toggle levers 11a and 11b are pressed in, the latter are not pressed through the cutouts 17a and 17b onto the wrist, each cutout base 23a and 23b is provided with a slope 41a and 41b, respectively, which tapers in the direction of the inner side 43 of the respective bracelet part 7a and 7b.

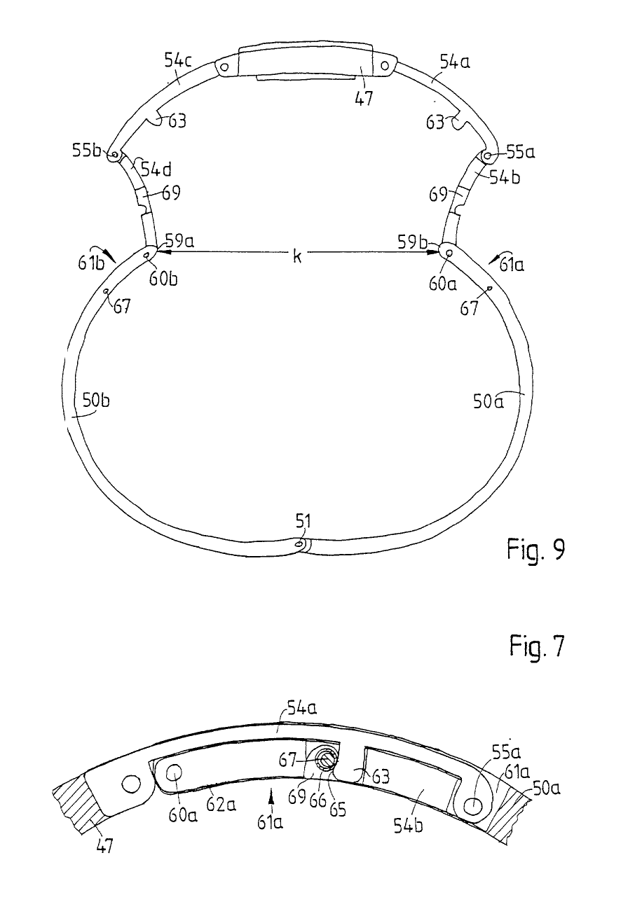

In order to open the arrangement, the thumb and index finger are used to press in the direction of the arrows 45a and 45b approximately in the center of the bracelet parts 7a and 7b, whereupon the watchcase 3, which forms the central closure part, springs radially outward, by a gripping distance, in direction 46. In order to be opened further into the state shown in FIG. 2, it is then possible for the watchcase 3 to be gripped laterally by the thumb and index finger or middle finger and drawn further in the radially outward direction in order further to increase the circumference of the arrangement. This opening operation is described hereinbelow for a variant with reference to FIGS. 8 and 9.

The two cutouts 17a and 17b have been described above in the form of through-passages. It is also possible, however, with the same effect, to use a cutout which does not pass right through the relevant bracelet part, i.e. a cutout base with a wall thickness in the direction of the inner side 43 would still remain. The abovedescribed cutout configuration, however, provides a more straightforward production with a nevertheless pleasing appearance.

It is not necessary either for the cutout base 23a and 23b, as has been illustrated above, to have a surface which is perpendicular to the longitudinal sides 19a to 19d of the cutouts 17a and 17b. It is also possible to use a curved surface. The abovedescribed cutout base 23a and 23b, however, is more straightforward to produce in mechanical terms.

It is not absolutely necessary for the eye-catching object to be the central part of the symmetrical hinged closure 1. It is also possible to use a central part without an eye-catching object and then for an eye-catching object to be arranged on one, or for an eye-catching object to be arranged on both, of the leg part 13a and/or 13b. It is not necessary either for the hinged closure to be symmetrical. It is also possible for it to be designed, for example, with just one toggle lever.

As has been described above, the strap has the two rigid bracelet parts 7a and 7b. These bracelet parts 7a and 7b may consist of a precious metal or of other metals and also of plastic. Instead of the rigid bracelet parts 7a and 7b, however, it is also possible to use flectually elastic bracelet parts.

The abovedescribed latching unit is to be understood merely as an example. It would also be possible for the axis of the pivot articulations 15a and 15b to be designed, for example, to project and to be resilient on both sides. In this case, an upwardly widening blind bore would have to be provided at the corresponding location in the longitudinal sides 19a to 19d.

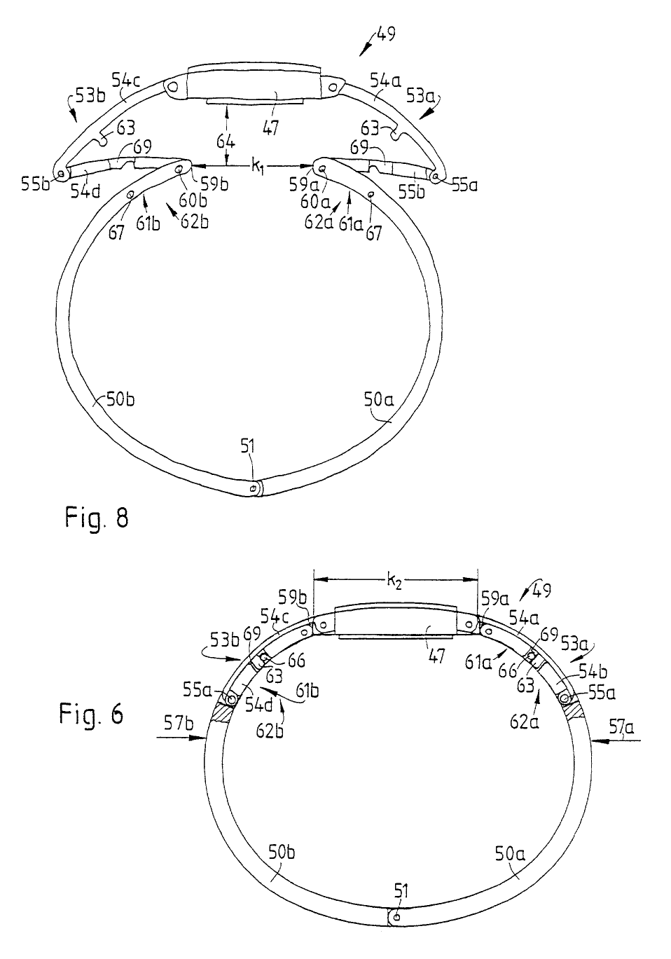

FIGS. 6 and 7 show a variant of the arrangement illustrated in FIGS. 1 to 5. Here too, a watchcase 47 is provided as the eye-catching object and central closure part of a symmetrical hinged closure. The bracelet parts 50a and 50b are designed analogously to the bracelet parts 7a and 7b and are likewise connected pivotably by a bracelet pivot articulation, in this case designated 51. Here too, the hinged closure 49 has in each case one toggle lever 53a and 53b on both sides. Each toggle lever likewise has two leg parts 54a, 54b and 54c, 54d, which are connected pivotably in each case by a pivot articulation 55a and 55b, respectively. In contrast to the arrangement illustrated in FIGS. 1 to 5, however, the leg parts 54a and 54c in this case are connected rigidly to the watchcase 47 (central closure part). However, analogously to the leg parts 13b and 13d, the leg parts 54b and 54d are moveable and are retained pivotably at the bracelet end regions 62a and 62b by in each case one pivot articulation 60a and 60b. This configuration results in the arrangement “springing open” satisfactorily by virtue of lateral pressing on the bracelet parts 50a and 50b beneath the cutouts 61a and 61b, described hereinbelow, in the direction of the arrows 57a and 57b. The springing-open action is made possible, in addition, in that, in the closed state of the hinged closure 49, the pivot-articulation axes 55a and 55b are spaced apart from the bracelet pivot articulation 51 by a shorter spacing than the pivot articulations 60a and 60b. FIG. 8 shows the “sprung-open” state of the arrangement. In this state, the spacing k₁ between the bracelet end edges 59a and 59b is smaller than the spacing k₂ in the closed state, as is shown in FIG. 6. This reduced spacing, however, also reduces the diameter of the arrangement; however, it is not small enough to pinch the wrist. In the “sprung-open” state, the watchcase 47 is raised up in a radially outward direction by a “gripping distance” 64. The watchcase can then be gripped laterally to good effect by the thumb and the index finger or middle finger, as a result of which, in order to increase the circumference further, the arrangement can be moved into the state shown in FIG. 9. This increases the spacing between the opposite bracelet end edges to k₃. It is then possible for the open arrangement to be slipped over the wrist.

The in each case two leg parts 54a to 54d of the toggle levers 53a and 53b are retained with latching action in a cutout 61a and 61b in the bracelet part 50a and 50b, said cutout being designed analogously to the cutout 17a and 17b. The magnitude of the latching force is selected such that the arrangement is not opened by accidental lateral impacts. It would also be necessary for these impacts to take place simultaneously on both sides. An impact on one side in the normal scale of events (i.e. one which does not cause injury) does not have any effect. The width of the in each case two link-design leg parts 54a, 54b and 54c, 54d is selected such that these parts can be introduced into the clearance 61a and 61b, respectively, with a clearance fit. The latching-action securing means is designed differently to the latching securing means of the arrangement shown in FIGS. 1 to 5.

The latching securing means illustrated in FIG. 7 shows an enlarged illustration of the leg part 54c. The leg part 54a is designed analogously to this, but in a mirror-inverted manner. This leg part 54c has, on both sides, in each case one extension 63 which projects downward approximately in the center and has a protuberance 65. In the closed state of the arrangement, this protuberance 65 engages around a tubular element 66 arranged in each cutout 61a and 61b. Each tubular element 66 is retained in the respective cutout by a crosspiece 67 running in it. In the closed state of the arrangement, the offset [sic] 63 engages through in each case one lateral notch 69 on the leg part 54b and 54d. The leg part 54d is mirror-symmetrical to the leg part 54b. For opening by lateral pressure being applied to the bracelet parts 5a and 50b, the protuberance 65 is pressed away, i.e. in the obliquely outward direction, from the tubular element 66 or crosspiece 67 and the latching is thus eliminated. By virtue of one latching part being designed as crosspiece 67 with an encasing tubular element 66, material abrasion can be reduced to a very pronounced extent and the service life of the latching unit can thus be significantly increased.

In addition, the crosspiece 67 arranged in each cutout 61a and 61b prevents the toggle levers 53a and 53b from being pressed through the cutouts 61a and 61b. As a result, the rigid fastening of the leg parts 54a and 54b on the central closure part 47 is additionally protected against being broken off.

In order to close the arrangement on the wrist, it is slipped over the hand. The two bracelet parts 50a and 50b are then lightly compressed between the thumb and one or more fingers of the other hand more or less at the location of the arrows 57a and 57b. On account of the leg part [sic] 54a and 54c connected rigidly and fixedly to the central closure part 47 (watchcase), the central closure part 47 comes to rest, during the compressing operation, over the gap between the two bracelet end edges 59a and 59b. If one then lets go of the bracelet parts 50a and 50b, the hinged closure 49 then collapses in on itself, provided it is located on the upper side of the wrist, on account of the gravitational force. The toggle levers 53a and 53b are then located in part in the cutouts 61a and 61b. By virtue of pressure then being applied to the leg parts 54a and 54c swung into the cutouts 61a and 61b, the toggle levers 53a and 53b then latch in a surface-flush manner into the cutouts 61a and 61b. Twisting of parts of the hinged closure 49 as a result of careless closure is no longer possible here; any possibilities of incorrect actuation are ruled out. For closure purposes, one will preferably apply pressure to the leg parts 54a and 54c at the location of the latching elements. However, it is also possible for closure to take place simply by virtue of pressing on the central closure part.

1. A circumferentially continuous arrangement which is to be worn preferably on the wrist and has a strap (7a, 7b; 50a, 50b) and a hinged closure (1; 49) which serves for changing the circumferential extent of the arrangement and has a central closure part (3; 47) and at least one toggle lever (11a, 11b; 53a, 53b) which is connected to the closure parts in one end region and has a strap end (5a, 5b) fastened at its other end region, characterized in that the collapsible toggle lever (11a, 11b; 53a, 53b), which is connected to the strap end (5a, 5b) and is offset circumferentially with respect to the central closure part (3; 47), and a central closure part (3; 47) are designed and connected to one another such that, for the direct transition from the closed state of the hinged closure (1; 49) to the open state, the central closure part (3; 47) is to be moved, or moves, outward.

2. Arrangement according to claim 1, characterized in that the hinged closure (1; 49), preferably the central closure part thereof, bears an eye-catching object (3; 47).

3. Arrangement according to claim 1 or 2, characterized by a cutout (17a, 17b; 61a, 61b) which is arranged in the strap end region (5a, 5b) adjoining the hinged closure (1; 49) and in which, with the hinged closure (1; 49) closed, in each case one toggle lever (11a, 11b; 53a, 53b) is positioned in the collapsed state, and by, preferably for each toggle lever (11a or 11b; 53a or 53b), in each case two leg parts (13a-d; 54a-d) which are connected to one another in an articulated manner by a pivot articulation (15a, 15b; 55a, 55b), and by, in particular, a second toggle lever (11a or 11b; 53a or 53b), in which case the hinged closure (1; 49) is preferably designed as a symmetrical unit with a toggle lever (11a, 11b; 53a, 53b) on both sides of the central closure part (3; 47).

4. Arrangement according to claim 3, characterized in that the sum of the thicknesses of the respectively first and second leg parts (13a/b, 13c/d; 54a/b, 54c/d) of each toggle lever (11a, 11b; 53a, 53b), apart from a tolerance, is equal to the thickness of the strap end region, and preferably in each case one leg part is of concave design (13a, 13c; 54a, 54c) and the other is of convex design (13b, 13d; 54b, 54d) with one of the curvature [sic] of the respective strap end region (5a, 5b) in order that, in the closed state of the arrangement, the collapsed toggle levers (11a, 11b; 53a, 54b) are positioned in a surface-flash manner in the respective cutout (17a, 17b; 61a, 61b).

5. Arrangement according to claim 3 or 4, characterized in that, in the closed state of the arrangement, each pivot articulation (15a, 15b; 55a, 55b) of the two leg parts (13a/13b, 13c/13d; 54a/54b, 54c/54d) comes to rest at a remote location from the central closure part (3; 47) and preferably one leg part (54a, 54c) of each toggle lever (53a, 54b) is connected fixedly, i.e. non-pivotably to the central closure part (47), as a result of which the central closure part can drop into a more or less closed state, from which it can be pressed into the fully closed state without there being any possibility of incorrect actuation.

6. Arrangement according to one of claims 1 to 5, characterized by a latching unit which retains the collapsed toggle levers (11a, 11b; 53a, 53b) in the relevant cutout (17a, 17b; 61a, 61b) until an opening force is applied.

7. Arrangement according to claim 6, characterized in that the latching unit is designed in two parts, a first latching-element part preferably being a slope (41a, 41b) [sic] which is arranged in the cutout (17a, 17b) and tapers, preferably in the vicinity of the cutout base (23a, 23b), towards the strap or bracelet outer side (39a, 39b) [sic], and the other latching-element part is a widened formation on the toggle lever (15a, 15b) [sic], it being the case that preferably one of the toggle levers (11a, 11b), in particular the toggle lever (13a, 13c) [sic] which comes to rest on top in the collapsed state, has a compressible gap (29a, 29b) which runs in the direction of the toggle link (15a, 15b) and is intended for producing a spring action.

8. Arrangement according to claim 3, characterized by a stop (41a, 41b; 65, 67) in each cutout (17a, 17b; 61a, 61b) for preventing the toggle lever (11a, 11b; 53a, 53b) from being pressed through the cutout (17a, 17b; 61a, 61b).

9. Arrangement according to claim 2, characterized in that the eye-catching object (3; 47) is a watchcase.

10. Arrangement according to one of claims 1 to 9, characterized in that the strap has at least two non-deformable bracelet parts (7a, 7b; 50a, 50b) which are adapted to the wrist contour, are designed preferably symmetrically to one another and are connected to one another pivotably by a bracelet pivot articulation (9; 51), and preferably each toggle lever (11a, 11b; 53a, 53b), the central closure part (3; 47) and the two bracelet parts (7a, 7b; 50a, 50b) are designed such that the spacing k₁ of the bracelet end edges (59a, 59b) from one another is only minimal when the central closure part (3; 47) is raised up outward by a gripping distance (64), in order that, by lateral pressing (45a, 45b; 57a, 57b) on the bracelet parts (7a, 7b; 50a, 50b), opening of the arrangement is possible by virtue of the central closure part (3; 47) springing upward from the closed state and being gripped in order to be opened further.
